(19) United States
(12) Patent Application Publication
(10) Pub. No.: US 2022/0310058 A1
(43) Pub. Date: Sep. 29, 2022

(54) CONTROLLED TRAINING AND USE OF TEXT-TO-SPEECH MODELS AND PERSONALIZED MODEL GENERATED VOICES

(71) Applicant: MICROSOFT TECHNOLOGY LICENSING, LLC, (US)

(72) Inventors: Sheng ZHAO, Beijing (CN); Li JIANG, Kirkland, WA (US); Xuedong HUANG, Bellevue, WA (US); Lijuan QIN, Redmond, WA (US); Lei HE, Beijing (CN); Binggong DING, Beijing (CN); Bo YAN, Sammamish, WA (US); Chunling MA, Beijing (CN); Raunak OBEROI, New Delhi (IN)

(21) Appl. No.: 17/280,008

(22) PCT Filed: Nov. 3, 2020
(86) PCT No.: PCT/CN2020/126047

§ 371 Date: Mar. 25, 2021

(51) Int. Cl. G10L 13/047; G10L 13/033; G10L 17/22; G10L 17/06

(52) U.S. Cl. CPC G10L 13/047; G10L 13/033; G10L 17/22; G10L 17/06

(57) ABSTRACT

Systems are configured for generating text-to-speech data in a personalized voice by training a neural text-to-speech machine learning model on natural speech data collected from a particular user, validating the identity of the user from which data is collected, and authorizing requests from users to use the personalized voice in generating new speech data. The systems are further configured to train a machine learning model as a neural text-to-speech model with generated personalized speech data.

### BACKGROUND

A text-to-speech (TTS) model is one that is configured to convert arbitrary text into human-sounding speech data. A TTS model, sometimes referred to as a voice font, usually consists of a front-end module, an acoustic model and a vocoder. The front-end module is configured to do text normalization (e.g., convert a unit symbol into readable words) and typically converts the text into a corresponding phoneme sequence. The acoustic model is configured to convert input text (or the converted phonemes) to a spectrum sequence, while the vocoder is configured to convert the spectrum sequence into speech waveform data. Furthermore, the acoustic model decides how the text will be uttered (e.g., in what voice.).

A source acoustic model is configured as a multi-speaker model trained on multi-speaker data. In some cases, the source acoustic model is further refined or adapted using target speaker data. Typically, the acoustic model is speaker dependent, meaning that either it is directly trained on speaker data from a particular target speaker, or by refining a source acoustic model using speaker data from a particular target speaker.

The model, if well trained, can convert any text into speech that closely mimics how the target speaker speaks, i.e., in same voice timbre and similar prosody. Training data for TTS models usually comprises audio data obtained by recording the particular target speaker while they speak and a set of text corresponding to the audio data (i.e., the textual representation of what the target speaker is saying to produce the audio data).

In some instances, the text used for training a TTS model is generated by a speech recognition model and/or natural language understanding model which is specifically configured to recognize and interpret speech and provide the textual representation of the words that are recognized in the audio data. In other instances, the speaker is given a pre-determined script from which read aloud, wherein the pre-determined script and the corresponding audio data is used to train the TTS model.

Initially, thousands of hours are required to build a source acoustic model. Then, vast amounts of training data are required to properly train the TTS model on one particular style. In some instances, the training/refining of the source acoustic model for a particular voice may require hundreds, sometimes thousands, of sentences of speech training data. Thus, to properly train the TTS model(s) for a plurality of different voices, a proportional amount of training data must be collected for each of the different target speaker voices. This is an extremely time-consuming and costly process to record and analyze data in each of the desired styles. Furthermore, data collection also has significant data privacy challenges, for example, in collecting enough data that does not violate a user's data privacy sharing settings.

Because of the aforementioned challenges, most TTS models that are commercially available are only able to read out text in one or a few pre-programmed voices. These pre-programmed voices can often sound synthesized or computerized. In view of the foregoing, there is an ongoing need for improved systems and methods for generating training data and training models, including the deployment of such models, for TTS models to produce speech data in a personalized voice.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed embodiments are directed towards embodiments for controlled training and use of text-to-speech (TTS) models and personalized model generated voices. In some instances, the disclosed embodiments include training a TTS model for generating speech data in a personalized voice. The generated speech data is used, in some instances, to further train a machine learning model for text-to-speech (TTS) conversion in a personalized voice. Additionally, some embodiments are directed to systems and methods for generating a personalized voice for a particular user profile.

Some embodiments include methods and systems for obtaining a first set of training data comprising natural speech data. In these embodiments, a computing system identifies a particular user profile and verifies authorization to use the first set of training data to train the TTS machine learning model by at least verifying that the first set of training data corresponds to the particular user profile. The computing system then trains the TTS machine learning model, which is configured to generate audio in the personalized voice, with the first set of training data. The TTS machine learning model is trained to generate audio in the personalized voice which corresponds to the particular user profile. In some instances, the first set of training data comprises an initial set of natural speech data recorded by the user reading a preset text utterance and a secondary set of natural speech data obtained from a usage log corresponding to the user.

In some instances, the disclosed embodiments are directed towards embodiments for using a TTS machine learning model to generate TTS data in a personalized voice. In such instances, a computing system receives a user request to generate text-to-speech data using the personalized voice. After accessing permission data associated with the personalized voice, the computing system determines that the permission data authorizes or restricts the use of the personalized voice as requested. Upon determining that the permission data authorizes the use of the personalized voice as requested, text-to-speech data is generated using the personalized voice or, alternatively, upon determining that the permission data restricts the use of the personalized voice as requested, text-to-speech data is not generated unless subsequent permission data is received that authorized the use of the personalized voice.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a computing environment in which a computing system incorporates and/or is utilized to perform disclosed aspects of the disclosed embodiments. The illustrated computing system is configured for text-to-speech generation and machine learning model training and includes hardware storage device(s) and a plurality of machine learning engines. The computing system is in communication with remote/third party system(s).

FIG. 2 illustrates one embodiment of a process flow diagram for training a machine learning model to generate personalized speech data for a target speaker.

FIG. 3 illustrates one embodiment of an example configuration for a neural TTS model according to embodiments disclosed herein.

FIG. 4 illustrates one embodiment of a process flow diagram showing a high-level view of generating training data and training a neural TTS model.

FIG. 5 illustrates an embodiment of a diagram having a plurality of acts associated with various methods for training a TTS machine learning model to generate speech data in a personalized voice.

FIG. 6 illustrates an embodiment of a diagram having a plurality of acts associated with various methods for obtaining training data for training a machine learning model for TTS generation in a personalized voice.

FIG. 7 illustrates one embodiment of a flow diagram having a plurality of acts associated with methods for obtaining a secondary set of natural speech data from a usage log corresponding to the user.

FIG. 8 illustrates one embodiment of a flow diagram having a plurality of acts associated with methods for identifying a source from which to obtain input text.

FIG. 9 illustrates one embodiment of a flow diagram having a plurality of acts for authorizing or restricting a request to generate TTS speech data using a personalized voice.

FIG. 10 illustrates one embodiment of a flow diagram having a plurality of acts for training a machine learning model to generate TTS speech data in a personalized voice and validating the training data on which the machine learning model is trained.

FIG. 11 illustrates one embodiment of a flow diagram having a plurality of acts associated with various methods for training a machine learning model for natural language understanding tasks, such as authorizing the use of training data configured to train a neural TTS model to generate TTS data in a personalized voice.

### DETAILED DESCRIPTION

Disclosed embodiments are directed towards embodiments for controlled training and use of text-to-speech (TTS) models and personalized model generated voices. In some instances, the disclosed embodiments include training a TTS model for generating speech data in a personalized voice.

The generated speech data is used, in some instances, to further train a machine learning model for text-to-speech (TTS) conversion in a personalized voice.

Additionally, some embodiments are specifically directed to systems and methods for generating a personalized voice for a particular user profile and for managing use of that user profile.

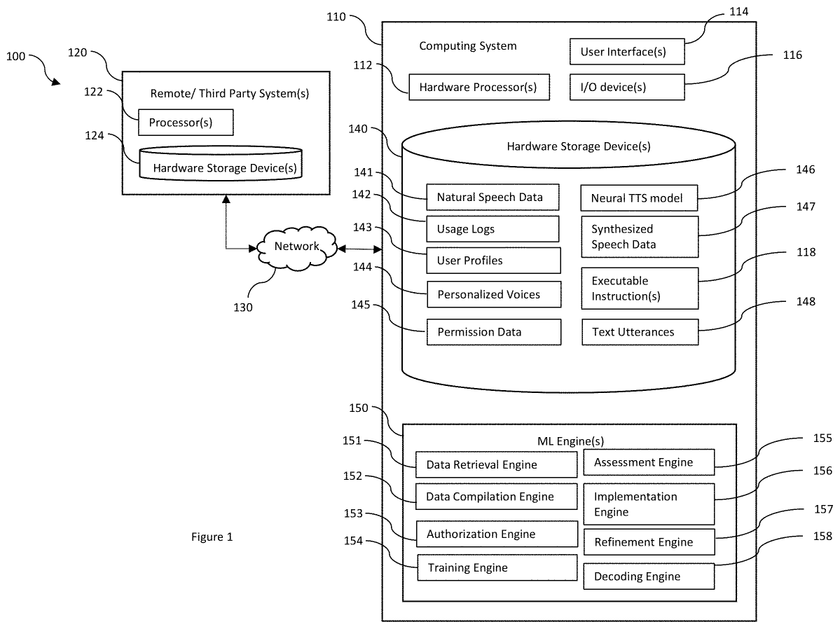

Attention will now be directed to FIG. 1, which illustrates components of a computing system 110 which may include and/or be used to implement aspects of the disclosed invention. As shown, the computing system includes a plurality of machine learning (ML) engines, models, and data types associated with inputs and outputs of the machine learning engines and models.

Attention will be first directed to FIG. 1, which illustrates the computing system 110 as part of a computing environment 100 that also includes remote/third party system(s) 120 in communication (via a network 130) with the computing system 110. The computing system 110 is configured to train a plurality of machine learning models for speech recognition, natural language understanding, text-to-speech, and more particularly, training neural TTS machine learning models to generate personalized speech data. The computing system 110 is also configured to generate training data configured for training machine learning models to generate speech data for a target speaker characterized a personalized voice. Additionally, or alternatively, the computing system is configured to operate a trained machine learning model for text-to-speech generation.

The computing system 110, for example, includes one or more processor(s) 112 (such as one or more hardware processor(s)) and a storage 140 (i.e., hardware storage device(s)) storing computer-executable instructions 118 wherein the storage 140 is able to house any number of data types and any number of computer-executable instructions 118 by which the computing system 110 is configured to implement one or more aspects of the disclosed embodiments when the computer-executable instructions 118 are executed by the one or more processor(s) 112. The computing system 110 is also shown including user interface(s) and input/output (I/O) device(s) 116.

The storage 140 is shown as a single storage unit. However, it will be appreciated that the storage 140 is, in some embodiments, a distributed storage that is distributed to several separate and sometimes remote and/or third party systems 120. The system 110 can also comprise a distributed system, in some embodiments, with one or more of the system 110 components being maintained/run by different discrete systems that are remote from each other and that each perform different tasks. In some instances, a plurality of distributed systems performs similar and/or shared tasks for implementing the disclosed functionality, such as in a distributed cloud environment.

In some embodiments, storage 140 is configured to store one or more of the following: natural speech data 141, usage logs 142, user profiles 143, personalized voices 144, permission data 145, a neural TTS model 146, synthesized speech data 147, executable instruction(s) 118 or text utterances 148.

In some instances, the storage 140 includes computer-executable instructions 118 for instantiating or executing one or more of the models and/or engines shown in computing system 110. In some instances, the one or more models are configured as machine learning models or machine learned models. In some instances, the one or more models are configured as deep learning models and/or algorithms. In some instances, the one or more models are configured as engines or processing systems (e.g., computing systems integrated within computing system 110), wherein each engine (i.e., model) comprises one or more processors (e.g., hardware processor(s) 112) and corresponding computer-executable instructions 118.

In some embodiments, natural speech data 141 comprises electronic content/data obtained from a target speaker. In some instances, the natural speech data 141 comprise(s) audio data, text data and/or visual data. Additionally, or alternatively, in some embodiments, the natural speech data 141 comprise metadata (i.e., attributes, information, speaker identifiers, etc.) corresponding to the particular speaker from which the data is collected. In some embodiments, the metadata comprises attributes associated with the identity of the speaker, characteristics of the speaker and/or the speaker's voice and/or information about where, when and/or how the speaker data is obtained.

In some embodiments, the natural speech data 141 and/or the source speaker data is raw data, wherein the speech data is recorded in real time from the target speaker, or set of target speakers. Additionally, or alternatively, in some embodiments, the natural speech data 141 comprise processed data (e.g., waveform format of the speaker data corresponding to the target speaker). For example, speech data (i.e., audio data) is extracted from previously recorded audio files and/or video files such as speech recognized by speech recognition models. In such instances, speech recognition models collect and store speech data from a speaker through authorized third-party applications, such as personal assistant devices, auditory search queries, recorded audio messages, and general conversation recognized by the speech recognition model.

This data can be aggregated over time for a specific application, across many applications, for a specific device, and/or across all of the user's devices. In some embodiments, applications include web, mobile, and/or desktop applications. In some embodiments, the referenced devices comprise speech-enabled devices such as, but not limited to, personal assistant devices, audio-enabled speakers, mobile phones, smart devices, internet-of-things (IoT) devices, laptops, and/or any device capable of listening, recognizing and recording natural speech data from particular and/or multiple speakers.

In some embodiments, the natural speech data 141 is collected and stored as part of a usage log (e.g., usage logs 142). Each usage log included in the usage logs 142 corresponds to a particular user. In some embodiments, the usage log collects speech data from a single application. In some embodiments, the user authorizes the usage log stores data from multiple sources and/or applications. For example, a user is able to authorize the storage and use of data collected from a virtual personal assistant application such as Cortana. In such instances, the user speaks to the virtual personal assistant to do web searches, email searches, send text messages, send emails, and other speech-enabled queries and actions. As the user continues to use virtual assistant, more and more speech data is collected and added into the usage log 143 associated with the user's user profile 143. This data can then be used as training data to train a neural TTS model 146 to be adapted to the user's voice.

In some instances, the usage logs 142 comprise audio data, text data and/or visual data. Additionally, or alternatively, in some embodiments, the usage logs 142 comprise metadata (i.e., attributes, information, speaker identifiers, etc.) corresponding to the particular speaker from which the data is collected. In some embodiments, the metadata comprises attributes associated with the identity of the speaker, characteristics of the speaker and/or the speaker's voice and/or information about where, when and/or how the speaker data is obtained. It should be appreciated that the usage log 142, in some instances, includes speech data recorded in real-time, speech data extracted from previously stored files, metadata, or a combination thereof.

In some embodiments, the databases include a database of user profiles 143 including information about the user. These user profiles 143 may be specific to particular speakers and may include particular speech attributes associated with those particular speakers. In some embodiments, the user profile 143 includes natural speech data 141, speech data as included in the usage log 142, a personalized voice 144 corresponding to the user of the user profile, permission data 145, and/or synthesized speech data 147. In some embodiments, the user profile 142 includes text utterances 148 collected from content authored by the user of the user profile 142 and/or content received by the user.

In some embodiments, as shown in FIG. 1, the hardware storage device 140 is configured to store a database of one or more personalized voices 144. In some instances, the personalized voice 144 is dataset of speech data (i.e., training data) corresponding to a particular speaker, wherein a neural TTS model is able to be trained on the personal speech data, such that the neural TTS model (e.g., vocoder or voice font) is configured to generate speech data in the personalized voice 144. In some instances, the personalized voice 144 is configured as a data model that can be applied to a system in order to generate speech data characterized by the personalized voice 144. In some instances, the personalized voice 144 includes metadata associated with the user. In some embodiments, the personalized voice 144 is linked to the corresponding permission data 145 (e.g., the metadata includes permission data).

In some embodiments, the personalized voices 144 further include tags to identify specific attributes about the personalized voice, including native language, secondary languages, user gender, voice prosody qualities, voice timbre qualities, or other descriptive features. In some instances, a personalized voice includes characteristics about pitch, intonation, speaking rate, speaking style, emotive description, etc. In some instances where a database of personalized voices 144 is authorized to be used by a particular user, the user is able to search for and select a particular personalized voice 144 based on tags (or other identifiers) matching the query by which the user searches in the database.

In some embodiments, the permission data 145 includes user-specified authorizations and/or restrictions associated with a user's natural speech data 141, usage log 142, personalized voice 144, synthesized speech data 147 and/or text utterances 148. For example, the user indicates when, where, and how the natural speech data 141 is collected, where it is stored, and when, where, and how it is used. In similar fashion, a primary user determines the parameters by which a computing system and/or secondary user is able to access and utilize data and/or models associated with the primary user. It should be appreciated that the personalized voice 144 is configured to sound as close to the natural speaking voice of the target speaker. In some instances, the personalized voice 144 is characterized by timbre characteristics of the speaker. Additionally, or alternatively, the personalized voice 144 is characterized by the prosody style of the speaker.

In some embodiments, a computing system has access to a plurality of different applications such as word processing, email, document creation, document consumption, proof reading, wherein the computing system is able to read aloud text content from these applications in the personalized voice 144 based on the permission data 145 associated with the personalized voice 144. In some embodiments, the computing system has access to a plurality of functions housed within a particular application, wherein the computing system is able to read aloud text for various functions according to the corresponding permission data 145.

In some embodiments, the personalized voice 144 corresponds to a neural TTS model trained on natural speech data 141 and/or synthesized speech data 147, wherein the neural TTS model is configured to output speech data in the personalized voice 144. In some embodiments, the hardware storage device 140 stores the neural TTS model 146, which is configured as a neural network that is trainable or is trained to convert input text to speech data. For example, a portion of an email containing one or more sentences (e.g., a particular number of machine-recognizable words) is applied to the neural TTS model, wherein the model is able to recognize words or parts of words (e.g., phonemes) and is trained to produce a corresponding sound to the phonemes or words.

In some embodiments, the hardware storage device 140 stores the neural TTS model 146, which is configured as a neural network that is trainable or is trained to convert input text to speech data. For example, a portion of an email containing one or more sentences (e.g., a particular number of machine-recognizable words) is applied to the neural TTS model, wherein the model is able to recognize words or parts of words (e.g., phonemes) and is trained to produce a corresponding sound to the phonemes or words.

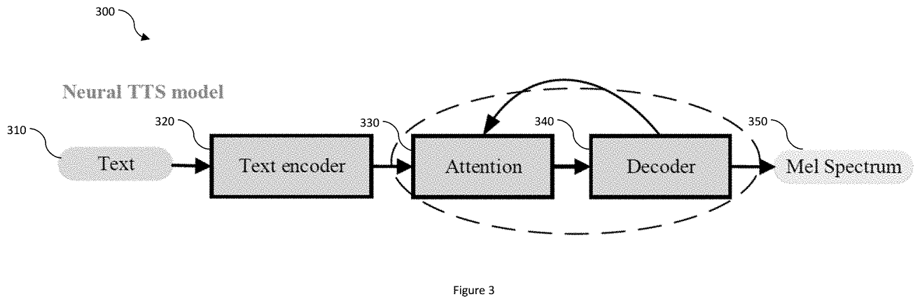

In some embodiments, the neural TTS model 146 is adapted for a particular target speaker. For example, target speaker data (e.g., natural speech data 141) comprising audio data including spoken words and/or phrases obtained and/or recorded from a target speaker. An example of a neural TTS model 300 is described in more detail below with reference to FIG. 3.

In some instances, the natural speech data 141 is formatted as training data, wherein the neural TTS model 146 is trained (or pre-trained) on the target speaker training data such that the neural TTS model 146 is able to produce speech data in the personalized voice of the target speaker based on input text (e.g., text utterances 148). In some instances, the text utterances 148 are computer generated text from a language model. In some instances, the text utterances 148 are extracted from third party sources such as newspapers, articles, books, and/or other public sources. In some instances, the text utterances 148 are authored by a particular user. In some instances, the text utterances 148 are extracted from within a particular application and/or content associated with a particular application, such as a media slideshow application, an email application, a calendar application, a document creator, a spreadsheet application, etc.

In some embodiments, the neural TTS model 146 is speaker independent, meaning that it produces arbitrary speech data based on one or a combination of target speaker datasets (e.g., natural speech data 141 and/or usage logs 142). In some embodiments, the neural TTS model 146 is a multi-speaker neural network, meaning that the model is configured to produce speech data corresponding to a plurality of discrete speakers/speaker profiles. In some embodiments, the neural TTS model 146 is speaker dependent, meaning that the model is configured to produce synthesized speech data 147 primarily for a particular target speaker.

In some embodiments, the neural TTS model 146 is further trained and/or adapted such that the model is trained on training data comprising and/or based on a combination of natural speech data 141 and synthesized speech data 147, such that the neural TTS model 146 is configured to produce speech data in the personalized voice of the target speaker. In some embodiments, the synthesized speech data 147 comprises personal content from a user generated by the neural TTS model 146, including narrated power-point slides, narrated word documents, narrated emails in the user's personalized voice or another voice the user has access to, or other text-based files that can be narrated to consumed auditorily by the user or authorized third-party.

In some instances, a user is able to select a particular personalized voice from a database of personalized voices 144, wherein the neural TTS model 146 is configured to convert input text to speech data based on one or more personalized voices 144. It should be appreciated that the user is able to access and utilize personalized voices 144 corresponding to other users when the associated permission data 145 created by the other users for their personalized voices allows for such usage/utilization by a third-party user.

An additional storage unit for storing machine learning (ML) Engine(s) 150 is presently shown in FIG. 1 as storing a plurality of machine learning models and/or engines. For example, computing system 110 comprises one or more of the following: a data retrieval engine 151, a data compilation engine 152, an authorization engine 153, a training engine 154, an assessment/evaluation engine 155, an implementation engine 156, an refinement engine 157 or a decoding engine 158 which are individually and/or collectively configured to implement the different functionality described herein.

For example, in some instances, the data retrieval engine 151 is configured to locate and access data sources, databases, and/or storage devices comprising one or more data types from which the data retrieval engine 151 can extract sets or subsets of data to be used as training data. In some instances, the data retrieval engine 151 receives data from the databases and/or hardware storage devices, wherein the data retrieval engine 151 is configured to reformat or otherwise augment the received data to be used as training data. Additionally, or alternatively, the data retrieval engine 151 is in communication with remote/third party systems (e.g., remote/third party systems 120) comprising remote/third party datasets and/or data sources. In some instances, these data sources comprise audiovisual services that record speech, text, images, and/or video to be used in cross-speaker style transfer applications.

In some embodiments, the data retrieval engine 151 accesses electronic content comprising natural speech data 141, usage logs 142, user profiles 143, personalized voices 144, permission data 145, synthesized speech data 147, and/or text utterances 148.

In some embodiments, the data retrieval engine 151 is a smart engine that is able to learn optimal dataset extraction processes to provide a sufficient amount of data in a timely manner as well as retrieve data that is most applicable to the desired applications for which the machine learning models/engines will be trained. For example, the data retrieval engine 151 can learn which databases and/or datasets will generate training data that will train a model (e.g., for a specific query or specific task) to increase accuracy, efficiency, and efficacy of that model in the desired natural language understanding application.

In some instances, the data retrieval engine 151 locates, selects, and/or stores raw recorded source data (e.g., natural speech data), wherein the data retrieval engine 151 is in communication with one or more other ML engines and/or models included in computing system 110 (e.g., data compilation engine 152, authorization engine 153, training engine 154, etc.). In such instances, the other engines in communication with the data retrieval engine 151 are able to receive data that has been retrieved (i.e., extracted, pulled, etc.) from one or more data sources such that the received data is further augmented and/or applied to downstream processes. For example, in some embodiments, the data retrieval engine 151 is in communication with the data compilation engine 152.

In some embodiments, the compilation engine 152 is configured for compilating data types and to configure data raw data into training data usable for training any one of the machine learning models described herein. The compilation model beneficially aggregates data to facilitate an increase in efficiency and accuracy of the training of the models. In some embodiments, the compilation engine 152 is configured to receive speaker data (e.g., natural speech data 141) and convert the raw speaker data into waveform data.

In some embodiments, the compilation engine 152 is configured to select, filter, and compile data from a plurality of sources including third party systems 120. In some embodiments, the compilation engine 152 is responsible for aggregating data over time and compiling the data for a user into a particular usage log 142. Additionally, the compilation engine 152 is configured to collect and store metadata comprising relevant information about the speech data in the usage logs 142.

In some embodiments, the ML Engine storage 150 comprises an authorization engine 153, which is configured to manage permission data (e.g., permission data 145) and facilitate the authorization or restriction of the use of raw data (e.g., natural speech data) and/or corresponding data models such as personalized voices 144. In some instances, the authorization engine 153 is configured to authorize or restrict the collection of natural speech data 141 from a user, wherein the authorization engine 153 is further configured to verify the identity of the user from which the data is being collected to ensure the data is attributed to the correct user profile. In some embodiments, the authorization engine 153 is configured to facilitate the use of a personalized voice 144 for specific user requests and/or within certain applications.

In some embodiments, the assessment engine 155 is in communication with one or more of the data retrieval engine 151, the compilation engine 152 or the authorization engine 153. In such networked embodiments, the assessment engine 155 is specifically configured to assess and evaluation data and process steps of the computing system functionality and corresponding methods. For example, the assessment engine 151, in some instances, is configured to ensure that the natural speech data 151 either directly recorded via preset text utterances and/or collected via the usage log 142 meets or exceeds a pre-determined audio data quality threshold. Additionally, or alternatively, the assessment engine 155 is configured to evaluate the synthesized speech data 147 generated by the neural TTS model 146 as compared to the natural speech data 141 on which the neural TTS model 146 was trained.

In some embodiments, the training engine 154 is in communication with one or more of the data retrieval engine 151, the compilation engine 152 or the assessment engine 155. In such embodiments, the training engine 154 is configured to receive one or more sets of training data from the data retrieval engine 151, the data compilation engine 152 and/or the authorization engine 153. After receiving training data relevant to a particular application or task, the training engine 154 trains one or more models on the training data for the particular natural language understanding applications, speech recognition applications, speech generation applications, and/or personalized voice applications. In some embodiments, the training engine 154 is configured to train a model via unsupervised training or supervised training.

In some embodiments, based on the permission data 145 accessed by the authorization engine 153, the training engine 154 is able to adapt the training processes and methods such that the training process produces a trained model configured to generate specialized training data that reflects the user-specified data privacy parameters. In some embodiments, the authorization engine 153 also enables a user to be able to delete data associated with the user's profile, including natural speech data, synthesized data, usage logs, and/or the user's personalized voice. Prior to deleting any or all of the user's profile data in response to receiving a request to delete, the system will, in some instance, verify the request to delete comes from the actual user based on confirming user authentication information received with the request. In some instances, where authorization is not verified, the system will refrain from deleting any of the user profile data. The system will also verify, in some instances, that authorization is made/granted, or previously stored in permission data 145, prior to using any of the user's personalized voice data. In this manner, the training engine 154 prevents an unauthorized user from using another user's personalized voice or associated data to train the model.

In some embodiments, the training engine 154 is configured to train a model (e.g., a neural TTS model 146, see also model 300 of FIG. 3) with training data (e.g., natural speech data 141) such that the machine learning model is configured to generate speech from arbitrary text as according to embodiments described herein. In some embodiments, the training engine 154 is configured such that the system is configured to use personalized audio to train a personalized speech recognition system to improve accuracy of the speech recognition.

In some embodiments, the computing system 110 includes a refinement engine 157. In some instances, the refinement engine 157 is in communication with the training engine. The refinement engine 157 is configured to refine the neural TTS model (e.g., neural TTS model 146) by adapting the model component (or sub-model) to a target speaker using natural speech data 141 and synthesized speech data 147 generated by a pre-trained neural TTS model.

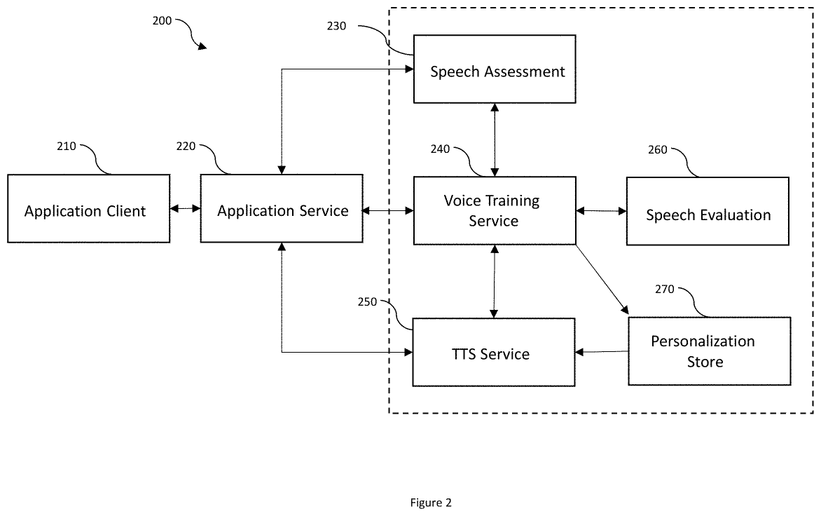

In some embodiments, the refinement engine 157 is configured to refine the encoder/decoder network of the neural TTS model 146 by employing a feedback loop between the encoder and decoder. The neural TTS model 146 is then trained and refined by iteratively minimizing the reconstruction loss from transforming the input text into speech data, and speech data back into text data. In some embodiments, the refinement engine 157 is also configured to refine and/or optimize any one or a combination of machine learning engines/models included in the computing system 110 to facilitate an increase in efficiency, efficacy, and accuracy of the engines/models. In some embodiments, the refinement engine 157 utilizes data output from the speech evaluation 260 and/or speech assessment 230 (see FIG. 2) to ensure that the synthesized speech data 147 is as closely matched to the corresponding natural speech data 141 for a particular user's personalized voice 144.

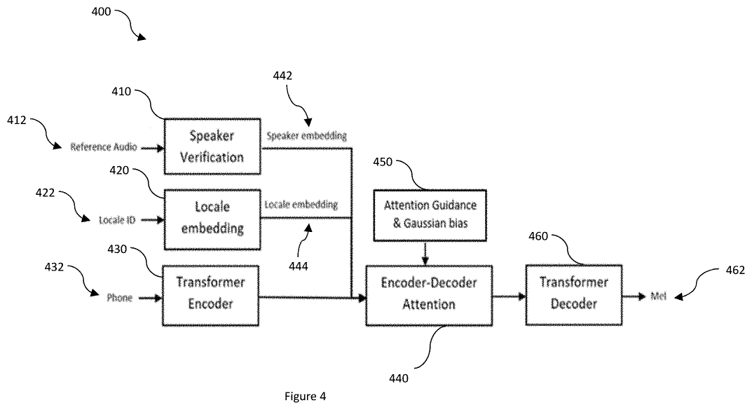

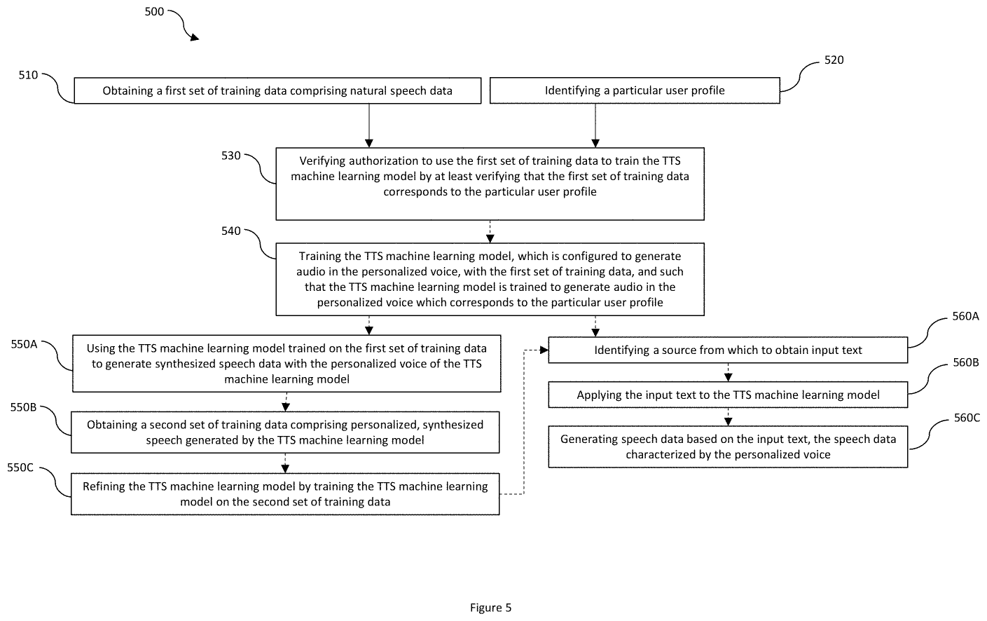

In some embodiments, the computing system 110 includes a decoding engine 158 (or an encoding-decoding engine) configured to encode and decode data. Generally, a decoder is neural network that takes the feature map, vector and/or tensor from an encoder and generates a best match to the intended input. In some embodiments, the encoding/decoding engine 158 is configured to encode text input to the neural TTS model 146 and decode the encoding to convert the input text into the mel-spectrum. (See FIG. 3). In some embodiments, the encoding/decoding engine 158 is configured to encode reference audio as part of the Mel spectrum generation process. (See FIG. 4).

In some embodiments, the computing system 110 includes an implementation engine 156 in communication with any one of the models and/or ML engines 150 (or all of the models/engines) included in the computing system 110 such that the implementation engine 156 is configured to implement, initiate or run one or more functions of the plurality of ML engines 150. In one example, the implementation engine 156 is configured to operate the data retrieval engines 151 so that the data retrieval engine 151 retrieves data at the appropriate time to be able to generate training data for the training engine 154.

In some embodiments, the implementation engine 156 facilitates the process communication and timing of communication between one or more of the ML engines 150. In some embodiments, the implementation engine 156 is configured to implement a voice conversion model to generate spectrogram data. Additionally, or alternatively, the implementation engine 156 is configured to perform a natural language understanding task by converting the input text (e.g., text utterances 148) into speech data (e.g., synthesized speech data 147) via the neural TTS model 146.

In some embodiments, the computing system is in communication with remote/third party systems 120 comprising one or more processor(s) 122 and one or more computer-executable instruction(s) 124. It is anticipated that, in some instances, the remote/third party systems 120 further comprise databases housing data that could be used as training data, for example, external speaker data. Additionally, or alternatively, the remote/third party systems 120 include machine learning systems external to the computing system 110. In some embodiments, the remote/third party systems 120 are software programs or applications.

Attention will now be directed to FIG. 2, which illustrates one embodiment of a process flow diagram for training a machine learning model to generate personalized speech data for a target speaker. As shown in the figure, an application client 210 is in communication with an application service 220. The application service 220 is in communication with a speech assessment 230, a voice training service 240, and a TTS service 250. The voice training service 240 is in communication with the speech evaluation 260 and the personalization store 270. The TTS service 150 is also in communication with the personalization store 270. It should be appreciated that the speech assessment 230, the voice training service 240, the TTS service 250, the speech evaluation 260, and the personalization store 270 are housed within an Azure Speech compliant, “eyes-off” system, wherein a human user does not view or have access to the data shared between the different services within the compliant system. In this manner, user data is secured and kept private from third party users and/or applications, except where the user and/or application has obtained the requisite permission from the user.

In some embodiments, the application client 210 is one or more of the following: a Microsoft Office application such as Word, PowerPoint, Excel, M365, and/or Outlook, a third party application, a speech-enabled device, a speech recorder, a text generator, and/or other application including content that can be created and/or consumed through text-to-speech technology. In some embodiments, the application service 220 is a function accessible within the application client 210. For example, a media slide show generator includes a feature to create and/or share slides that include automatically generated narrations. In some instances, a user may wish to have the narration be in the user's own voice without having to manually record each of the text utterances included in the slides.

A user can generate a personalized voice via the voice training service 240 (e.g., training engine 154) which is able to train a neural TTS machine learning model with speech data corresponding to the user using methods described herein. In some embodiments, the voice training service 240 collects and compiles a data model for a personalized voice for the user. Before the voice training service 240 includes portions of user speech data into the data model, the speech data is assessed via the speech assessment service 230. The speech assessment service 230 is configured to assess whether the quality of the speech data meets or exceeds a pre-determined quality threshold.

After TTS service 250 is trained on the personalized voice data model, the TTS service 250 is able to generate speech data in the personalized voice based on text utterances received from the application service 220 and/or application client 210. The TTS service 250, in some instances, performs the speech data generation in real-time as a user inputs or otherwise provides text utterances. In some instances, the TTS service 250 receives batches of text utterances to convert to speech data.

After personalized, synthesized speech data is generated by the TTS service 250, the speech data is relayed through the voice training service 240 to a speech or MOS evaluation service, wherein the synthesized speech data is compared to natural, original speech data from the user. Upon determining that the synthesized speech data does not match the natural, original speech data, in some instances, the voice training service 240 collects more speech data to further train the TTS service 250.

In some embodiments, once the synthesized speech meets or exceeds a quality threshold determined by comparing the synthesized speech to the natural speech, the voice training service 240 outputs the personalized voice 144 to be stored in the personalization store 270. The personalization store 270 is configured to store a plurality of personalized voices 144, each corresponding to a particular user and associated with user-determined permission settings.

Other applications in which the system 200 is applicable include productivity scenarios such as reading aloud emails, web-pages, word documents in sender's voice, reading aloud to proof-read documents, and reading text translated from a different language, all while maintaining user data privacy. In addition, in some applications, a user generates audio and/or audio-visual content utilizing the user's own personalized voice stored in the personalization store 270.

Attention will now be directed to FIG. 3 which illustrates one example of a TTS machine learning model that can be trained is a neural TTS model 300, which includes a text encoder 320 and a decoder 340. In some instances, attention 330 is used by the model to direct and inform the encoding-decoding process at various layers of the model. The neural TTS model 300 is able to generate output (e.g., speech waveform data) in the Mel spectrum or other spectrum such that the generated output is speech data based on the input text 310. The Mel spectrum 350 (i.e., synthesized speech data) is characterized by the personalized voice of a particular user.

Referring now to FIG. 4, one embodiment of an example text-to-speech component of the voice model is illustrated. For example, TTS module 400 is shown having an encoder-decoder network (e.g., transformer encoder 430 configured to encode the phoneme data 432 and a decoder 460 configured to decode the encoded data output by the plurality of encoders) with attention layer 440. The text-to-speech module 400 is configured to receive a plurality of data types including reference audio 412 from a source speaker (e.g., natural speech data 141), as well as a speaker ID corresponding to the target speaker. Using the speaker ID and/or the reference audio 410, the speaker's identity is verified. In some embodiments, the computing system is able to identify a particular target speaker using a speaker look up table (LUT) which is configured to store a plurality of speaker IDs corresponding to a plurality of target speakers and associated target speaker data (including target speaker Mel spectrum data).

In some embodiments, the speaker verification system 410 is configured to extract one or more feature vectors from the speech detected in the reference audio 412. The extracted feature(s) is/are compared to previously stored features corresponding to a particular speaker, wherein each speaker has at least one unique feature by which the computing system can identify the speaker and verify their identity. The feature vectors are represented in a multi-dimensional space, such that every vector is a different speaker. The speaker verification 412 then obtains the speaker embedding for the extracted feature vector and encodes the speaker embedding during the encoding-decoding process.

In some embodiments, the speaker verification 410 is also configured to receive other types of identification information including biometric data, authorization tokens, or passwords which the system compares against previously stored identification information (locally and/or from a remote authentication system). This verification step ensures that the reference audio 412 corresponds to the correct user and that the user of the system has permission to use the reference audio 412 in the training and speech data generation process.

The system 400 is also configured to receive a locale ID 422 via the locale embedding 420. The local ID 422 is configured as a language vector identifying which language construct (e.g., English, Spanish, etc.) to encode during the TTS process. Additionally, the system 400 is configured to receive phone data 432 (e.g., phonemes) via the transformer encoder 430. The phonemes are representative of the text from which the speech data will be generated.

Based on the input shown in FIG. 4, the TTS module 400 is able to generate spectrogram data (e.g., Mel spectrum data 462) that is characterized by the personalized voice based on data obtained from the reference audio 412 and the speaker embedding 442. In some embodiments, the spectrogram data is characterized by the prosody style of the target speaker based on data extracted from the target speaker data (e.g., phoneme data, pitch contours, and/or energy contours).

In some embodiments, the TTS module 400 is configured to convert speech data from a target speaker (e.g., a source speaker) in a first language into speech that is in a second language, while maintaining the same acoustic features in the target speaker's personalized voice. In other words, the converted speech mimics the voice of the target speaker but includes pronunciations native to the second language. The languages are identified via the local ID 422 and locale embedding 422 representing the first language and locale embedding 444 representing the second language.

In some embodiments, wherein the TTS module 400 is trained on the sound of a particular speaker (e.g., acoustic features of the speaker's voice) and the content of speech typical of the particular speaker (e.g., phoneme information, word sequence, vocabulary, other language information). In such instances, the speaker's personalized voice 144 refers to both the acoustic qualities of the speech data, as well as the language choices of the speaker. Thus, in some embodiments, input text (e.g., text utterances 148) is applied to the neural TTS module, wherein the TTS module 400 is configured to convert speech data in a first language based on the initial input text into the speaker's personalized language (e.g., typical word choices, word sequencing, dialect conversion, etc.), wherein the converted/edited text utterance maintains the same acoustic features of the target speaker's personalized voice 144. For example, in some embodiments, the neural TTS module 400 recognizes greetings included in the original text utterance and replaces the greeting with a greeting more typical to the particular speaker. After the text utterance is edited, the edited text utterance is then “spoken aloud” by the neural TTS module 400 in the speaker's personalized voice 144.

Attention will now be directed to FIG. 5 which illustrates a flow diagram 500 that includes various acts (act 510, act 520, act 530, act 540, act 550A, act 550B, act 550C, act 560A, act 560B, and act 560C) associated with exemplary methods that can be implemented by computing system 110 for obtaining training data and training a machine learning model for text-to-speech data generation, such as for example, by transforming text into speech data in a personalized voice.

The first illustrated act includes an act of verifying authorization to user the first set of training data to train the TTS machine learning model (e.g., neural TTS model 146 and/or neural TTS model 300) by at least verifying that the first set of training data corresponds to the particular user profile (act 530). Subsequently, the computing system trains the TTS machine learning model which is configured to generate audio in the personalized voice, with the first set of training data, and such that the TTS machine learning model is trained to generate audio in the personalized voice (e.g., personalized voice 144) which corresponds to the particular user profile (act 540).

In some instances, the TTS machine learning system trained on the first set of training data is used to generate synthesized speech data (e.g., synthesized speech data 147) with the personalized voice of the TTS machine learning model (act 550A). Additionally, in some instances, a second set of training data comprising personalized, synthesized speech generated by the TTS machine learning model is obtained (act 550B). Thereafter, the TTS machine learning is refined by training the TTS machine learning model on the second set of training data (act 550C).

Additionally, or alternatively, after training the TTS machine learning model on the first set of training data, the computing system identifies a source from which to obtain input text (e.g., text utterances 148) (act 560A). The input text is applied to the TTS machine learning model (act 560B), and speech data is generated based on the input text (act 560C). The speech data is characterized by the personalized voice.

With regard to the acts described in FIG. 5, it will be appreciated that they can be performed in different ordering than the ordering that is explicitly shown in the flow diagram 500. For instance, while acts 510 and 520 may performed in parallel with each other, in some alternative embodiments, acts 210 and 220 are performed in series. Furthermore, in some embodiments, acts 560A, 560B, and 560C follow in series after act 550C. Alternatively, acts 550A, 550B, and 550C are performed in parallel with acts 560A, 560B, and 560C.

It will also be appreciated that the act of generating TTS speech data may occur with the same computer device(s) that performed the aforementioned acts (e.g., acts 510-560C), or alternatively by one or more different computer device(s) of a same distributed system.

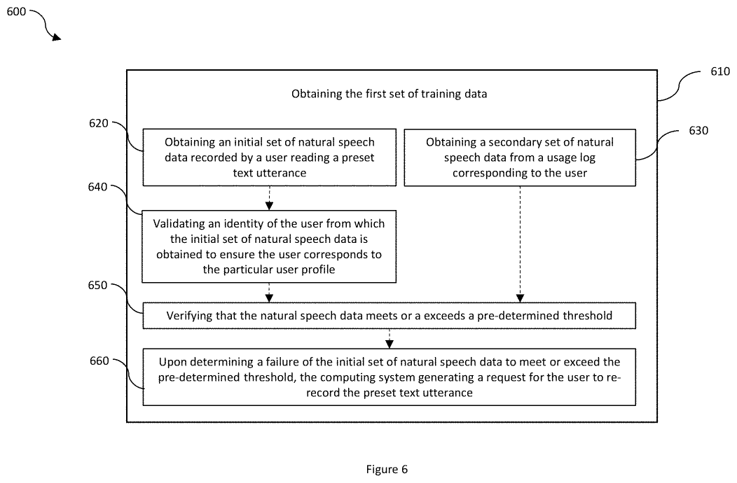

Attention will now be directed to FIG. 6, which illustrates a diagram 600 of various acts (act 620, act 630, act 640, act 650, and act 660), which can also be implemented by computing system 110 and which may be performed as part of the aforementioned act of obtaining the first set of training data (act 610). For example, one referenced technique for obtaining a first set of training data includes an act of obtaining an initial set of natural speech data recorded by a user reading a preset text utterance (act 620). In some instances, after obtaining an initial set of natural speech data, the computing system validates an identity of the user from which the initial set of natural speech data is obtained to ensure the user corresponds to the particular user profile (act 640), prior to using the obtained data for building a personalized voice and/or training/refining any model with the data. In some embodiments, the obtaining of the initial set of natural speech data (i.e., recording a dynamic sentence in real-time) also signals a user's consent to the subsequent building of the personalized voice with the recording.

Another act associated with obtaining the first set of training data includes obtaining a secondary set of natural speech data from a usage log (e.g., usage logs 142) corresponding to the user (act 630). In some embodiments, act 630 is performed in parallel with act 620 as shown, or in series (e.g., before or after act 620). Subsequently, the computing system verifies that the natural speech data meets or exceeds a pre-determined threshold (act 650). In some instances, upon determining a failure of the initial set of natural speech data to meet or exceed the pre-determined threshold, a request is generated for the user to re-record the preset text utterance (e.g., text utterance 148).

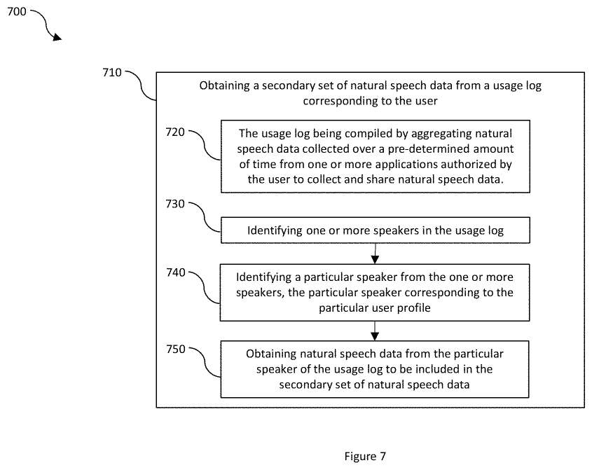

Attention will now be directed to FIG. 7, which illustrates a diagram 700 that includes various additional acts (act 720, act 730, act 740, and act 750) associated with the referenced act of obtaining a secondary set of natural speech data from a usage log (act 710), similar to the associated act 630 of FIG. 6, and which may be implemented by the components of computing system 110.

As shown in FIG. 7, the acts associated with act 710 include an act of compiling the usage log (e.g., usage log 143) by aggregating natural speech data (e.g., natural speech data 141) collected over a pre-determined amount of time from one or more applications authorized by the user to collect and share natural speech data (act 720) and identifying one or more speakers in the usage log (act 730) and a particular speaker from the one or more speakers (act 740). Notably, the particular speaker corresponds to the particular user profile (e.g., user profiles 143). Subsequently, natural speech data is obtained from the identified particular speaker of the usage log to be included in the secondary set of natural speech data (act 750).

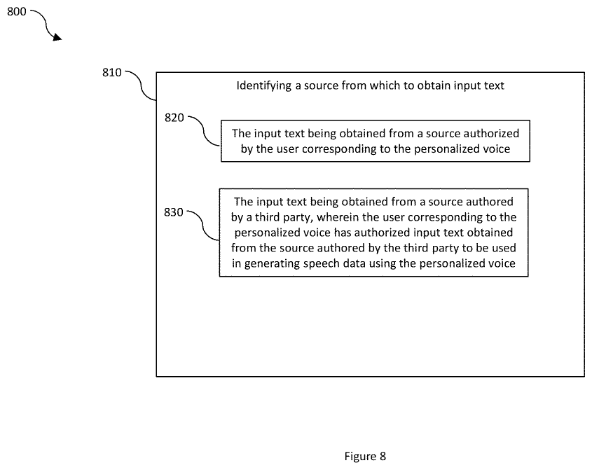

Attention will now be directed to FIG. 8, which illustrates a diagram 800 associated with the act of identifying a source from which to obtain input text (act 810) and corresponding additional acts (act 820 and 830) that may be performed while identifying the source from which to obtain input text (act 810). For instance, these additional acts include an act of obtaining the input text (e.g., text utterances 148) obtained from a source authorized by the user corresponding to the personalized voice (e.g., personalized voices 144) (act 820) and additionally, or alternatively, obtaining the input text from a source authored by a third party (e.g., third party system 120 and/or a user corresponding to user profiles 143), wherein the user corresponding to the personalized voice has authorized input text obtained from the source authored by the third party to be used in generating speech data using the personalized voice (act 830).

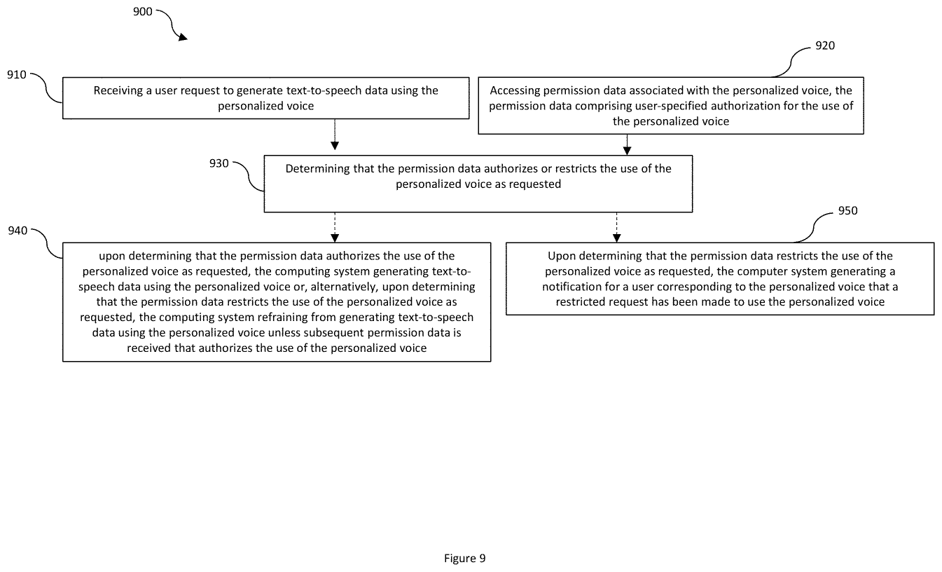

Attention will now be directed to FIG. 9, which illustrates a flow diagram 900 that includes various acts (act 910, act 920, act 930, act 940, and act 950) associated with exemplary methods for authorizing or restricting a request to generate TTS speech data using a personalized voice and that can be implemented by computing systems, such as computing system 110 described above in reference to FIG. 1.

The first illustrated act includes an act of a computing system (e.g., computing system 110) receiving a user request to generate text-to-speech data (e.g., synthesized speech data 147) using the personalized voice (e.g., personalized voices 144) (act 910). Before or after the request is received, the computing system accesses permission data (e.g., permission data 145) associated with the personalized voice, the permission data comprising user-specified authorization for the use of the personalized voice (act 920). It should be appreciated that acts 910 and 920 are may also performed in parallel, as shown or, as previously mentioned, these acts may be performed in series with each other.

The permission data authorizes or restricts the use of the personalized voice as requested (act 930). upon determining that the permission data authorizes the use of the personalized voice as requested, the computing system generating text-to-speech data using the personalized voice, or, alternatively, upon determining that the permission data restricts the use of the personalized voice as requested, the computing system refraining from generating text-to-speech data using the personalized voice unless subsequent permission data is received that authorizes the use of the personalized voice (act 940).

Flow diagram 900 also includes an act of, upon determining that the permission data restricts the use of the personalized voice as requested, the computer system generating a notification for a user corresponding to the personalized voice that a restricted request has been made to use the personalized voice (act 950).

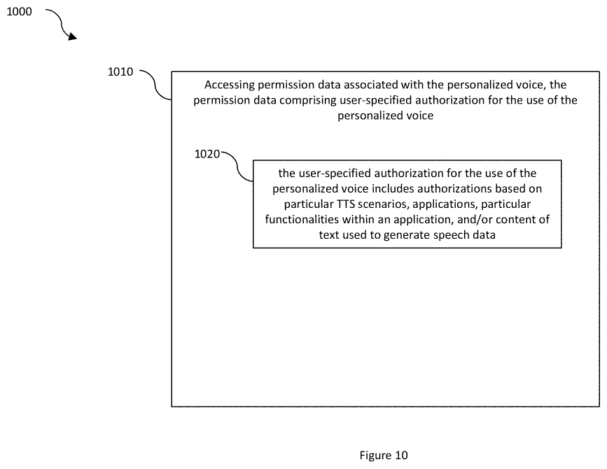

Attention will now be directed to FIG. 10, which includes a diagram 1000 identifying an act (act 1010) that corresponds to act 920 of FIG. 9 for accessing permission data associated with the personalized voice, as well as one additional act that may be performed when implementing act 1010. As noted, this additional act includes determining the user-specified authorization for the use of the personalized voice includes authorizations based on particular TTS scenarios, applications, particular functionalities within an application, and/or content of text used to generate speech data (act 1020) prior to determining that the permission data authorizes or restricts the use of the personalized voice (act 930).

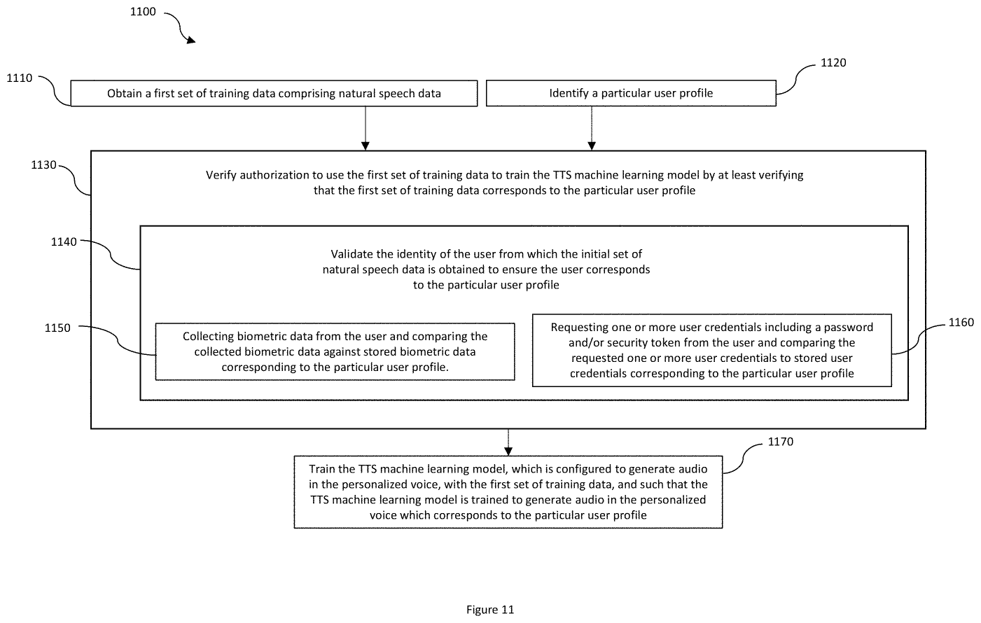

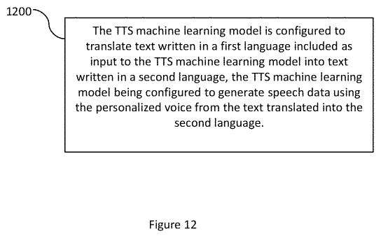

Attention will now be directed to FIG. 11, which illustrates a flow diagram 1000 that includes various acts (act 1110, act 1120, act 1130, act 1140, act 1150, act 1160, and/or act 1170) which are associated with various methods for training a machine learning model for natural language understanding tasks, for example, authorizing the use of training data configured to train a neural TTS model to generate TTS data in a personalized voice and which may be implemented by computing system 110.

The first illustrated acts include an act of obtaining a first set of training data comprising natural speech data (e.g., natural speech data 141) (act 1110) and an act of identifying a particular user profile (e.g., user profiles 143) (act 1120). The next act includes the computing system then verifies authorization to use the first set of training data to train the TTS machine learning model by at least verifying that the first set of training data corresponds to the particular user profile (act 1130).

In some embodiments, authorization is verified by validating the identity of the user from which the initial set of natural speech data is obtained to ensure the user corresponds to the particular user profile (act 1140). In some instances, the computing system validates the identity of the user by collecting biometric data from the user and compares the collected biometric data against stored biometric data corresponding to the particular user profile (act 1150).

Additionally, or alternatively, in some embodiments, the computing system validates the identity of the user by requesting one or more user credentials including a password and/or security token from the user and comparing the requested one or more user credentials to stored user credentials corresponding to the particular user profile (act 1160). Subsequent to act 1130, the TTS machine learning model, which is configured to generate audio in the personalized voice, is trained with the first set of training data. For example, the TTS machine learning model is trained to generate audio in the personalized voice which corresponds to the particular user profile (act 1170).

In view of the foregoing, it will be appreciated that the disclosed embodiments provide many technical benefits over conventional systems and methods for generating machine learning training data configured to train a machine learning model for generating text-to-speech data, specifically in a personalized voice. In some instances, the text-to-speech generation eliminates the need for recording vast amounts of data from a target speaker to build an accurate personalized voice for the target speaker. Furthermore, it provides a system for generating spectrogram data and corresponding text-to-speech data in an efficient and fast manner. This is in contrast to conventional systems using only target speaker data where it was difficult to produce large amounts of training data.

In some instances, the disclosed embodiments provide technical benefits over conventional systems and methods for training a machine learning model to perform text-to-speech data generation. For example, by training a TTS model via methods described herein, the TTS model is able to quickly be trained to produce speech data in the personalized voice of the target speaker. Furthermore, it increases the availability and access to sources of natural language data that previously were not accessible because of the data privacy controls and identify verifications.

Embodiments of the present invention may comprise or utilize a special purpose or general-purpose computer (e.g., computing system 110) including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media (e.g., storage 140 of FIG. 1) that store computer-executable instructions (e.g., component 118 of FIG. 1) are physical hardware storage media/devices that exclude transmission media. Computer-readable media that carry computer-executable instructions in one or more carrier waves or signals are transmission media. Thus, by way of example, and not limitation, embodiments of the invention can comprise at least two distinctly different kinds of computer-readable media: physical computer-readable storage media/devices and transmission computer-readable media.

Physical computer-readable storage media/devices are hardware and include RAM, ROM, EEPROM, CD-ROM or other optical disk storage (such as CDs, DVDs, etc.), magnetic disk storage or other magnetic storage devices, or any other hardware which can be used to store desired program code means in the form of computer-executable instructions or data structures and which can be accessed by a general purpose or special purpose computer.

A “network” (e.g., network 130 of FIG. 1) is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry, or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer implemented method for training a text-to-speech (TTS) machine learning model configured to generate speech data in a personalized voice, the method being implemented by a computing system that includes at least one hardware processor, and the method comprising:
the computing system obtaining a first set of training data comprising natural speech data;
the computing system identifying a particular user profile;
the computing system verifying authorization to use the first set of training data to train the TTS machine learning model by at least verifying that the first set of training data corresponds to the particular user profile; and
the computing system training the TTS machine learning model, which is configured to generate audio in the personalized voice, with the first set of training data, and such that the TTS machine learning model is trained to generate audio in the personalized voice which corresponds to the particular user profile.

2. The method of claim 1, wherein obtaining the first set of training data further comprises:
obtaining an initial set of natural speech data recorded by a user reading a preset text utterance; and
obtaining a secondary set of natural speech data from a usage log corresponding to the user, the first set of training data comprising the initial set of natural speech data and the secondary set of natural speech data.

3. The method of claim 2, wherein the verifying authorization includes the computing system validating an identity of the user from which the initial set of natural speech data is obtained to ensure the user corresponds to the particular user profile.

4. The method of claim 2, usage log being compiled by aggregating natural speech data collected over a pre-determined amount of time from one or more applications authorized by the user to collect and share natural speech data.

5. The method of claim 4, further comprising:
the computing system identifying one or more speakers included in the usage log;
the computing system identifying a particular speaker from the one or more speakers, the particular speaker corresponding to the particular user profile; and
the computing system obtaining natural speech data from the particular speaker to be included in the secondary set of natural speech data.

6. The method of claim 2, further comprising:
after obtaining the initial set of natural speech data and the secondary set of natural speech data, the computing system verifying that the natural speech data meets or exceeds a pre-determined quality threshold; and
the computing system filtering the natural speech data such that the first set of training data includes only the natural speech data that meets or exceeds the pre-determined quality threshold.

7. The method of claim 6, further comprising:
upon determining a failure of the initial set of natural speech data to meet or exceed the pre-determined quality threshold, the computing system generating a request for the user to re-record the preset text utterance.

8. The method of claim 1, further comprising:
the computing system using the TTS machine learning model trained on the first set of training data to generate synthesized speech with the personalized voice of the TTS machine learning model;
the computing system obtaining a second set of training data comprising personalized, synthesized speech generated by the TTS machine learning model; and
the computing system refining the TTS machine learning model by training the TTS machine learning model on the second set of training data.

9. The method of claim 1, further comprising:
the computing system identifying a source from which to obtain input text;
the computing system applying the input text to the TTS machine learning model; and
the computing system generating speech data based on the input text, the speech data characterized by the personalized voice.

10. The method of claim 9, the input text being obtained from a source authored by the user corresponding to the personalized voice.

11. The method of claim 9, the input text obtained from a source authored by a third party, wherein the user corresponding to the personalized voice has authorized input text obtained from the source authored by the third party to be used in generating speech data using the personalized voice.

12. The method of claim 1, further comprising:
training the TTS machine learning model on multiple sets of training data, wherein each set of training data corresponds to a unique personalized voice, such that the TTS machine learning model is configured to output speech data in one or more unique personalized voices.

13. A computer implemented method for using a text-to-speech (TTS) machine learning model to generate TTS data in a personalized voice, the method being implemented by a computing system that includes at least one hardware processor, and the method comprising:
the computing system receiving a user request to generate text-to-speech data using the personalized voice;
the computing system accessing permission data associated with the personalized voice, the permission data comprising user-specified authorizations for the use of the personalized voice;
the computing system determining that the permission data authorizes or restricts the use of the personalized voice as requested; and
upon determining that the permission data authorizes the use of the personalized voice as requested, the computing system generating text-to-speech data using the personalized voice or, alternatively, upon determining that the permission data restricts the use of the personalized voice as requested, the computing system refraining from generating text-to-speech data using the personalized voice unless subsequent permission data is received that authorizes the use of the personalized voice.

14. The method of claim 13, further comprising:
upon determining that the permission data restricts the use of the personalized voice as requested, the computer system generating a notification for a user corresponding to the personalized voice that a restricted request has been made to use the personalized voice.

15. The method of claim 13, wherein the user-specified authorization for the use of the personalized voice includes authorizations based on particular TTS scenarios, applications, particular functionalities within an application, and/or content of text used to generate speech data.

16. The method of claim 13, wherein the TTS machine learning model is configured to translate text written in a first language included as input to the TTS machine learning model into text written in a second language, the TTS machine learning model being configured to generate speech data using the personalized voice from the text translated into the second language.

17. A computing system configured to generate a personalized voice for a particular user profile, wherein the computing system comprises:
one or more processors; and
one or more computer readable hardware storage devices that store computer-executable instructions that are structured to be executed by the one or more processors to cause the computing system to at least:
identify a first set of training data comprising natural speech audio data;
identify a particular user profile;
verify authorization to use the first set of training data to train the TTS machine learning model by at least verifying that the first set of training data corresponds to the particular user profile; and
train a TTS machine learning model, which is configured to generate audio in the personalized voice, with the first set of training data, and such that the TTS machine learning model is trained to generate audio in the personalized voice which corresponds to the particular user profile.

18. The computing system of claim 17, the computer-executable instructions being executable by the one or more processors to further cause the computing system to verify authorization by validating an identity of the user from which the initial set of natural speech data is obtained to ensure the user corresponds to the particular user profile.

19. The computing system of claim 18, wherein validating the identity of the user from which the initial set of natural speech data is obtained to ensure the user corresponds to the particular user profile further comprises validating the identity of the user by collecting biometric data from the user and comparing the collected biometric data against stored biometric data corresponding to the particular user profile.

20. The computing system of claim 18, wherein validating the identity of the user from which the initial set of natural speech data is obtained to ensure the user corresponds to the particular user profile further comprises validating the identity of the user by requesting one or more user credentials including a password and/or security token from the user and comparing the requested one or more user credentials to stored user credentials corresponding to the particular user profile.
